(19) United States
(12) Patent Application Publication
(10) Pub. No.: US 2025/0035243 A1
(43) Pub. Date: Jan. 30, 2025

(54) CLAMP FOR CONNECTING EXHAUST PIPES

(71) Applicant: RB Distribution, Inc., Colmar, PA (US)

(72) Inventors: Ricardo Llorente RUIZ, Perkasie, PA (US); Harold Haeyong LEE, Horsham, PA (US); Eric TRYSON, Willow Grove, PA (US); John Whitney IDEN, Perkasie, PA (US)

(73) Assignee: RB Distribution, Inc., Colmar, PA (US)

(21) Appl. No.: 18/357,677

(22) Filed: Jul. 24, 2023

(51) Int. Cl. F16L 23/036

(52) U.S. Cl. CPC F16L 23/036

(57) ABSTRACT

A clamp for joining pipes has a body that is generally rectangular and a ledge that includes a fastener. The body fits over one pipe with the ledge between the pipes and the fastener passes through an aperture in the second pipe. The pipes are joined by applying a closure to the fastener.

### BACKGROUND

Many exhaust systems suffer failures in the bolts or fasteners that hold exhaust components, such as exhaust pipes and manifolds, together. While it is possible to disassemble the parts and replace the failed bolt or fastener, this is often time consuming and expensive. Additionally, disturbing the existing parts that have been joined and possible fixed in position can result in the need for further repairs.

One known attempt to address the issue of connecting exhaust pipes and securing a tight connection offers a generally rectangular upper portion with a formed configuration that overlies the flared end of one exhaust pipe and has a depended bolt that is welded to the upper portion for insertion in the collar of a mating exhaust pipe. This known solution has alignment issues with the bolt and the weld is subject to separation from the upper portion.

### SUMMARY

The disclosed clamp has a generally rectangular portion that is vertical to overlay one end of an exhaust pipe and a horizontal portion that includes a bolt positioned to enter a bolt hole in the associated exhaust pipe. Hence, the present solution provides a reconfigured clamp that eliminates the dependence on a weld for securing a fastener and provides better alignment of the pipes.

### BRIEF DESCRIPTION OF THE DRAWINGS

FIG. 1 is a perspective view of the clamp and associated components;

FIG. 2 is an exploded view with a sectioned portion to illustrate the assembly of a fastener to the clamp body;

FIG. 3 illustrates the assembly of the clamp on an illustrative exhaust system;

FIG. 4 is a top perspective view of the clamp body;

FIG. 5 is a bottom perspective view of the clamp body;

Figure is a front plane view of the clamp body;

FIG. 7 is a rear plane view of the clamp body;

FIG. 8 is a right side plane view of the clamp body in FIG. 5;

FIG. 9 is a left side plane view of the clamp body in FIG. 5;

FIG. 10 in a top plane view of the clamp body in FIG. 5;

FIG. 11 in a bottom plane view of the clamp body in FIG. 5; and,

FIG. 12 illustrates the clamp body in a use environment.

### DETAILED DESCRIPTION

The disclosed clamp will be described in detail with reference to the drawings wherein the same or similar element is identified with the same indicator throughout the description.

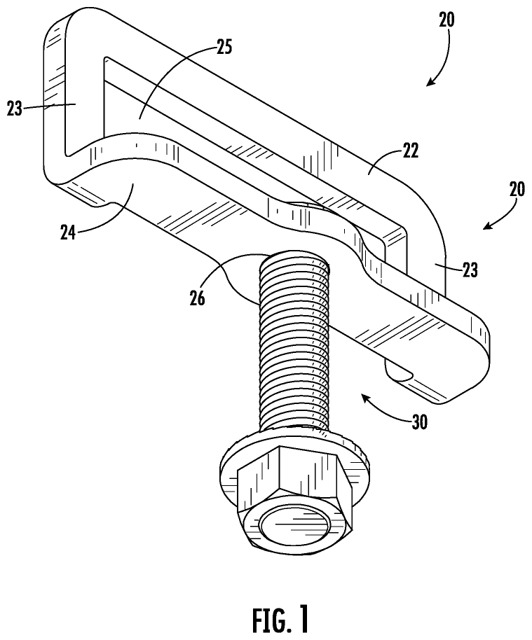

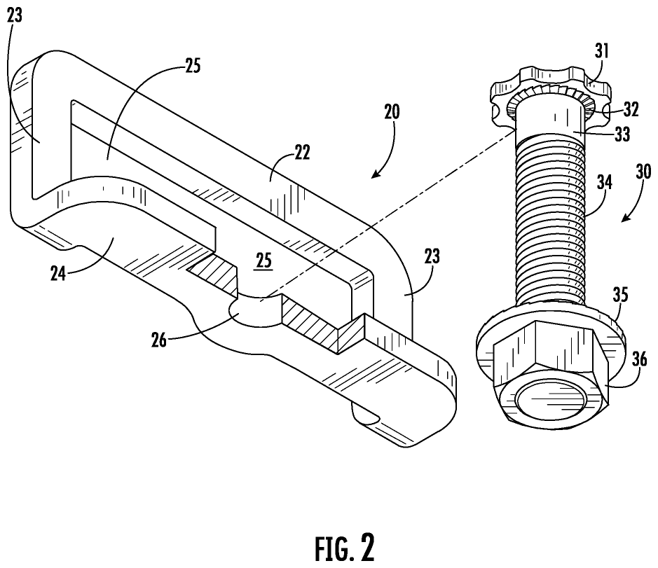

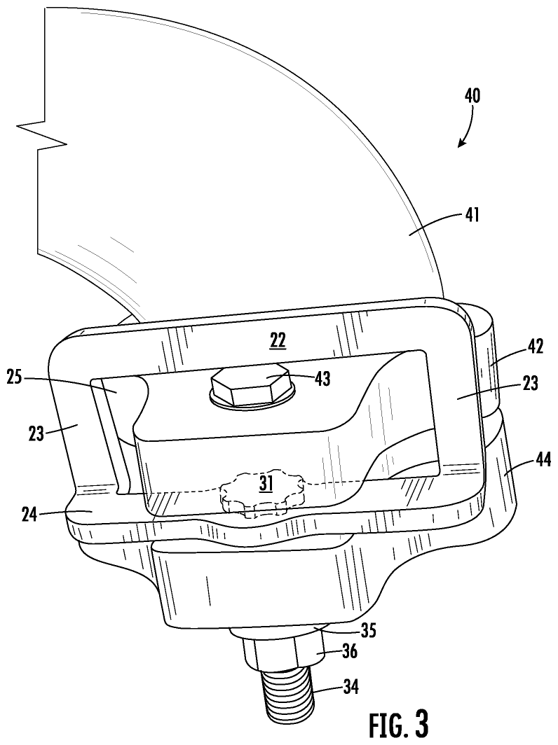

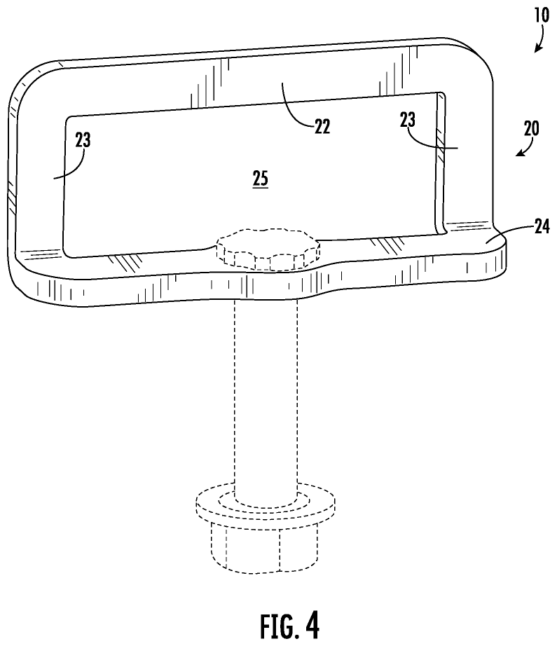

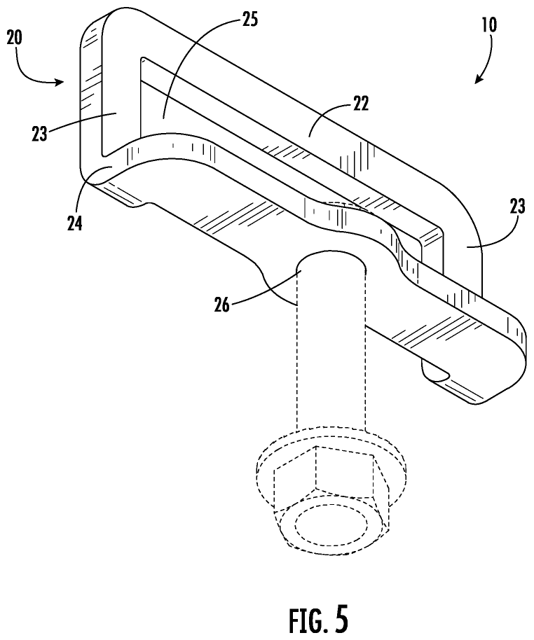

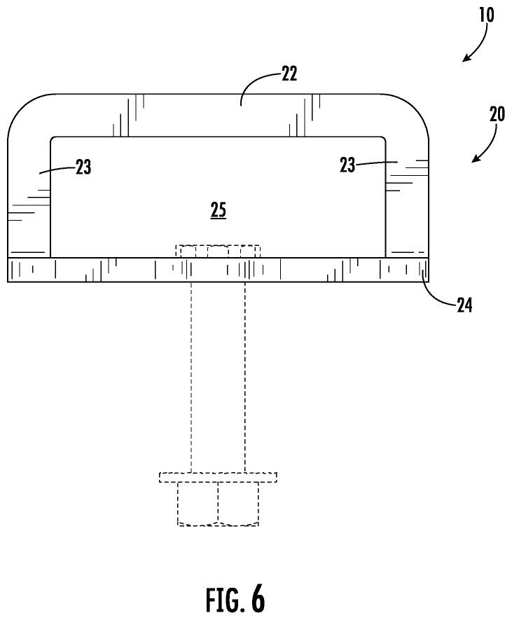

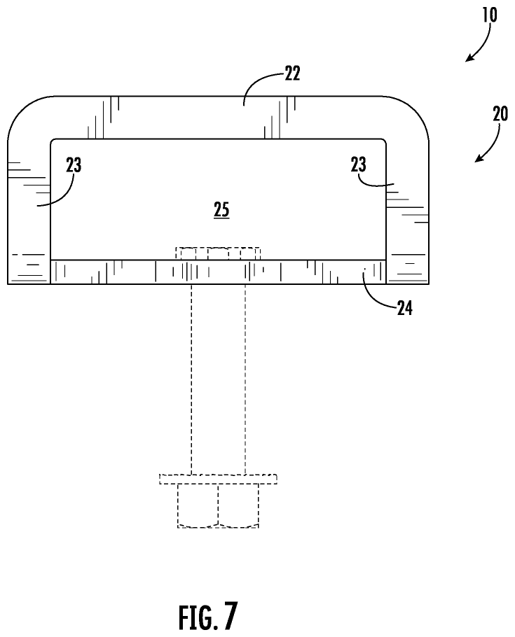

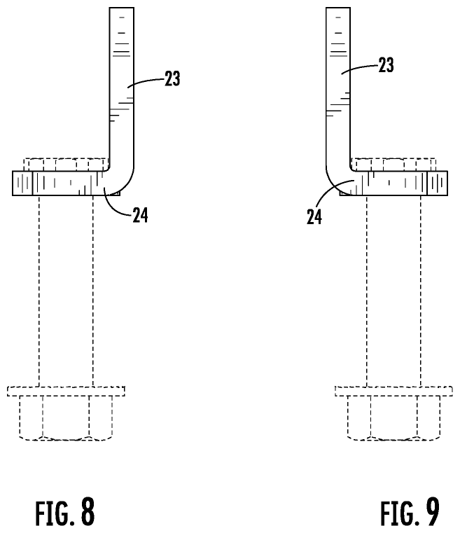

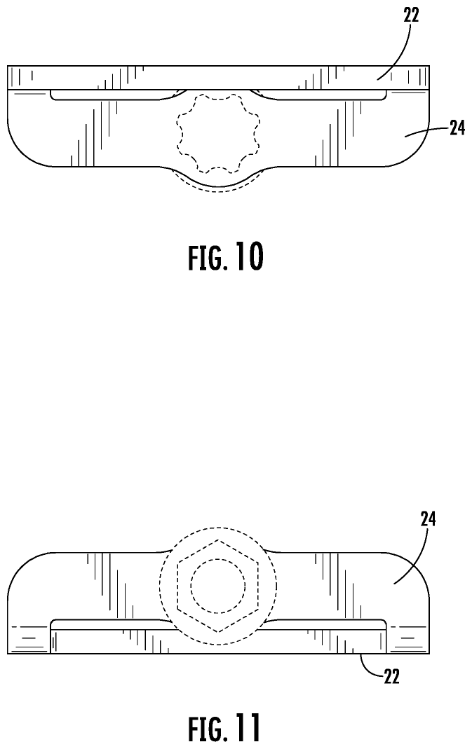

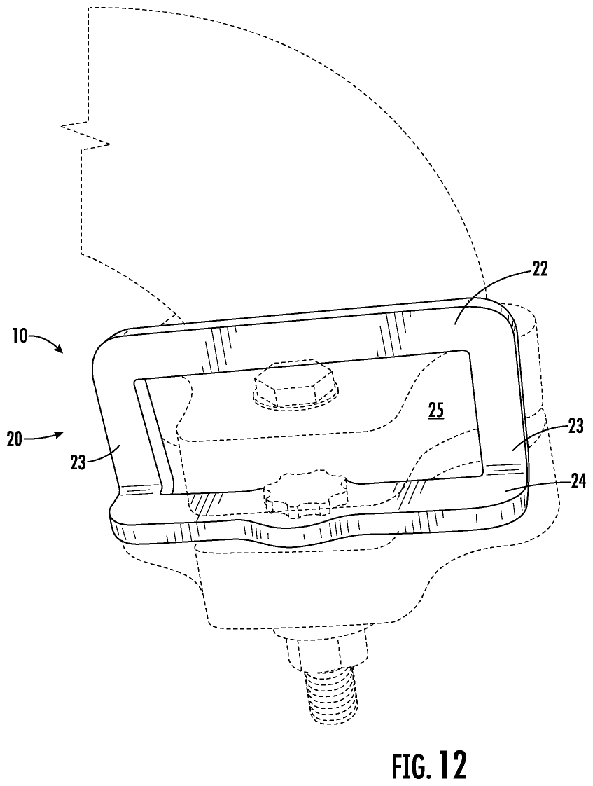

The structure of the clamp 10 is illustrated in FIGS. 1 and 2. The body 20 of clamp 10 is formed by bar or rail members 22 and 23, and flatter plate like member 24, which combine to define an opening 25. As will be explained with reference to FIG. 3, the opening 25 is dimensioned according t the parts to be joined. Referring again to FIGS. 1 and 2, it can be seen that the rail members 22 and 23 are generally straight and lie in a first plane and the ledge 24 is in a second plane, which is generally perpendicular to the first plane.

As shown in FIGS. 1 and 2, member 24 has a through hole 26 that receives the fastener 30. The fastener 30 has head 31 that is dimensioned to rest on member 24. The serrations 32 and shoulder 33 are sized to form a press fit with the ledge 24 surrounding the through hole 26, which eliminates the need for welding the fastener 30 to the body 20. The illustrated fastener has threaded shaft 34 that receives a washer 35 and a threaded closure 36.

Use of the clamp 10 is illustrated in FIG. 3. As noted above, an exhaust system 40 typically has a manifold exhaust header or pipe 41 that terminates in a flange 42 that has a through hole for a bolt, represented by the head 43. The head 43 is what typically remains when the bolt fails and it is typically frozen to the manifold flange 42. As shown in FIG. 3, the opening 25 is sized to fit over the bolt head 43 with a portion of the flange 42 extending through the opening 25, and the ledge 24 is positioned between the parts 42 and 44 flanges.

Still with reference to FIG. 3, it can be seen that the through hole 26 in ledge 24 is located to be generally aligned beneath the head 34 so the parts are aligned. The second part of the exhaust 40 may be a fixed flange or a slidable collar 44, that is associated exhaust pipe that is part of an exhaust discharge or transfer system, with a through hole for the fastener 30. As noted above, when the blot fails collar 44 may still have a piece of the bolt remaining in the through hole and it will need to be removed. Once the through hole in collar 44 is clear, the fastener 30 is inserted in the collar 44. By moving the clamp body 20 over the head 43 in the manifold pipe flange 42 and tightening the closure 36 on the fastener 30, the two flanges 42 and 44 of the exhaust system 40 are joined together.

The illustrated body 20 of clamp 10 is a metal stamping metal that has the desired opening 25 and the through hole 26 in the ledge 24. It is then formed to have the ledge 24 in a second plane that is generally perpendicular to the first plane of rails 22 and 23. The fastener 30 is pressed into the through hole 26 and the head 43 rest on the ledge 24. A longitudinal axis through the fastener 30 is generally perpendicular to the ledge 24.

What is claimed is:

1. A clamp for joining pipes with flanges, the clamp comprising:
a body with a first portion that is generally rectangular and lies in a first plane and a second portion that defines a ledge that lies in a second plane;
the first portion has an opening that is configured to fit over a flange associated with a first pipe;
the ledge has a through hole that is configured to receive a fastener that is dimensioned to pass through an aperture in a second pipe;
whereby the pipes are joined by locating the first portion on a flange associated with a first pipe, locating the fastener in an aperture in a second pipe, and applying a closure to the fastener.

2. The clamp of claim 1, wherein the first plane and the second plane are non-parallel planes.

3. The clamp of claim 1, wherein the first plane and the second plane are perpendicular planes.

4. The clamp of claim 1, wherein the opening in the first portion of the body is defined by three rails.

5. The clamp of claim 4, wherein the three rails are linear.

6. The clamp of claim 1, wherein the fastener is pressed in the through hole of the ledge.

7. The clamp of claim 1, wherein the fastener is threaded and has a head that abuts the ledge.

8. A clamp for joining exhaust pipes with flanges, the clamp comprising:
a body with a first portion that is generally rectangular and lies in a first plane and a second portion that defines a ledge that lies in a second plane;
the first portion has an opening that is dimensioned to fit over a flange associated with an exhaust manifold pipe;
the ledge has a through hole that is dimensioned to receive a fastener that is sized to pass through an aperture in a pipe associated with an exhaust discharge system;
whereby the pipes are joined by locating the first portion on a flange associated with an exhaust manifold pipe, locating the fastener in an aperture in a pipe associated with an exhaust discharge system, and applying a closure to the fastener.

9. The clamp of claim 8, wherein the first plane and the second plane are non-parallel planes.

10. The clamp of claim 8, wherein the fastener is threaded and has a head that abuts the ledge.

11. The clamp of claim 10, wherein the fastener is pressed in the through hole of the ledge.

12. A clamp for joining two pipes with flanges, the clamp comprising:
a stamped body having a rectangular portion with an opening that is dimensioned to fit over a flange associated with a first pipe and a ledge that extends from the rectangular portion; and
a fastener with has a threaded portion sized to pass through an aperture in a second pipe is pressed into an aperture in the ledge;
whereby the pipes are joined by locating the rectangular portion on a flange associated with a first pipe, locating the fastener in an aperture in a second pipe, and applying a closure to the fastener.

13. The clamp of claim 12, where in the fastener has a head that abuts the ledge.

14. The clamp of claim 12, wherein the fastener is pre-positioned in the ledge to align with through holes in a pair of flanges.
